(19) United States
(12) Patent Application Publication
(10) Pub. No.: US 2003/0040989 A1
(43) Pub. Date: Feb. 27, 2003

(54) Expense reimbursement application method of an accounting system used in computerized financial management

(75) Inventors: Yeun-Jonq Lee, Taipei (TW); Fang-Chen Tsao, Taipei (TW); Hao-Liang Chen, Taipei (TW)

Correspondence Address: BACON & THOMAS, PLLC, 625 SLATERS LANE, FOURTH FLOOR, ALEXANDRIA, VA, 22314

(73) Assignee: VIA Technologies, Inc., Taipei (TW)

(21) Appl. No.: 10/103,710

(22) Filed: Mar. 25, 2002

(30) Foreign Application Priority Data
Aug. 27, 2001 (TW) 090121098

(51) Int. Cl. G06F 17/60

(52) U.S. Cl. 705/30

(57) ABSTRACT

Expenses reimbursement application method, mainly used in the accounting system of the enterprise resource planning (ERP) system. Wherein, for expense applicants, it provides an “employee expense application function setup” in order to combine the inputs of general expense and petty cash applications, and the input operations are performed by the expense applicants; for petty cash keepers, it provides a “petty cash management function setup” to allow the petty cash keepers to manage petty cash accounts; for accountants, it provides an “expense application and account establishment function setup”, which allows the accountants to inquire the expense application data inputted by general employees and the petty cash keepers and reduces the input time of the accounting operations.

### BACKGROUND OF THE INVENTION

(1) Field of the Invention

The present invention relates to an improved expense reimbursement application method, and more particularly to an improved expense reimbursement application method of the enterprise resource planning (ERP) system that is utilized in a computer system.

(2) Description of the Prior Art

For common enterprises, business operation expenses, besides of all types of costs, generally refer to all kinds of expenses occurred during the sales or management activities. The expenses may include employee salaries, stationery and printing expenses, travel expenses, social expenses, fast delivery expenses, postal and cable expenses, shipping expenses, advertising expenses, repairs expenses, etc. during the sales or management activities in a company. Please refer to FIG. 1, which is the flow chart of the employee expense reimbursement application process in a prior general ERP system. The employee salaries are calculated and paid by the salary evaluating system, all the other expenses have to go through the following process: applied by employees according to some kinds of receipts and expense application forms 10, reviewed and approved by managers 11, inputted into the computer systems to establish accounts by accountants 110, and then paid to the applicants 111 by treasurers based on data of the established accounts.

Furthermore, the common enterprises may require some kinds of the expenses smaller than a set amount, such as small-figure delivery expenses, book expenses, stationery expenses, taxi expenses, etc., to be paid from a pre-set amount of cash, which is referred to as petty cash. Petty cash is established for the purposes of simplifying the application process and satisfying the needs for quick acquisition of cash. After the petty cash keepers receive the receipts and forms reviewed and approved by the managers, cash is paid to the applicants 112. At a set period (such as at the end of each month) or after accumulating a set amount of money, the keepers apply to the accountants for reimbursement funds 113, the accountants input the data into the system to establish accounts 114, then the treasurers pay the petty cash keepers according to the data of the established accounts 115.

The stated general system, besides that the applicants need to know beforehand whether the applied expenses are paid by petty cash account, lacks the controlling and tracing mechanisms during the application procedures. For the accountants, they have to input all application data, which wastes a lot of manpower and time. While for the applicants, they have to know the application procedures for all kinds of expenses, or they might encounter troubles during application or unnecessary business operations due to the errors of the application procedures. Many enterprises, in order to reduce these types of errors, hire extra employees to specialize in handling these types of business operations.

For the petty cash keepers, they have to record the details of each payment, and, at a set period or after accumulating a set amount of money, organize data and receipts needed to be approved by the managers and then handed over to the accountants for the proceeding of data input and account establishment operations. However, it has become a heavy workload for the petty cash keepers or the accountants because of the large quantity of operation data.

Some systems with office automation or flow management may provide the computerized approval function, however, they do not combine the petty cash application system and the expense application system. For the applicants, they still have to decide the suitable expense application procedures by themselves, and then input the application data into the system. Generally speaking, it still needs a clerk to input the data from one to several departments.

Some other types of electronic approval systems, since not within the structure of an ERP system, can only perform the electronic approval functions. After the expense applications being approved, data have to be transferred from the electronic approval system to the financial system of ERP through transference programs, and, according to the legal requirements, only the original receipts can be used as the proofs of expenses in the accounting operations. Therefore, the electronic approval systems can't eliminate the transfer functions of the original receipts, the managers and accountants still have to review and approve the related original receipts.

### SUMMARY OF THE INVENTION

The first objective of the present invention is to provide an improved expense reimbursement application method, which is able to effectively satisfy the need of every employee in the company, and provides a more automatic method for expense reimbursement application, assures the accuracy of account entries, and, at the same time, reduces human entry and decision-making time.

The second objective of the present invention is to provide an improved expenses reimbursement application method to combine the expense reimbursement application entry of general expenses applications and petty cash applications.

The other objective of the present invention is to provide an improved expenses reimbursement application method, which is used to reduce the time wasted by the accountants to enter the account data, and effectively reduce the workload of the accountants.

The further objective of the present invention is to provide an improved expenses reimbursement application method, which effectively simplifies the work of accumulating and applying reimbursement fund for the petty cash keepers.

In order to achieve the stated objectives, the improved expenses reimbursement application method in according to the present invention includes: the expense reimbursement application begins with setting the upper limit of the petty cash; the applicants enter the data for expense reimbursement application and provide payment receipts for review and approval; the system decides whether the applied amount exceeding the petty cash upper limit, and if exceeding the petty cash upper limit, then it proceeds the expense application procedures, while if not exceeding the petty cash upper limit, then it proceeds the petty cash application procedures; at a set period or after accumulating a set amount of money, the petty cash keeper applies to the accountant to proceed the petty cash reimbursement application procedures; and finally, the expenses reimbursement application process is completed.

One advantage of the improved expenses reimbursement application method in according to the present invention is to provide, for the expenses applicants, an employee expense application function setup.

The other advantage of the improved expenses reimbursement application method in according to the present invention is to provide, for the accountants, an expense application and account establishment function setup, so that the accountants are able to inquire the expense application data inputted by the general employees and the petty cash keepers.

The further advantage of the improved expenses reimbursement application method in according to the present invention is to provide, for the petty cash keepers, a petty cash management function setup to allow the petty cash keepers manage petty cash accounts.

### BRIEF DESCRIPTION OF THE DRAWINGS

The present invention will now be specified with reference to its preferred embodiment illustrated in the drawings, in which

FIG. 1 is a flow chart of a prior expense reimbursement application operation;

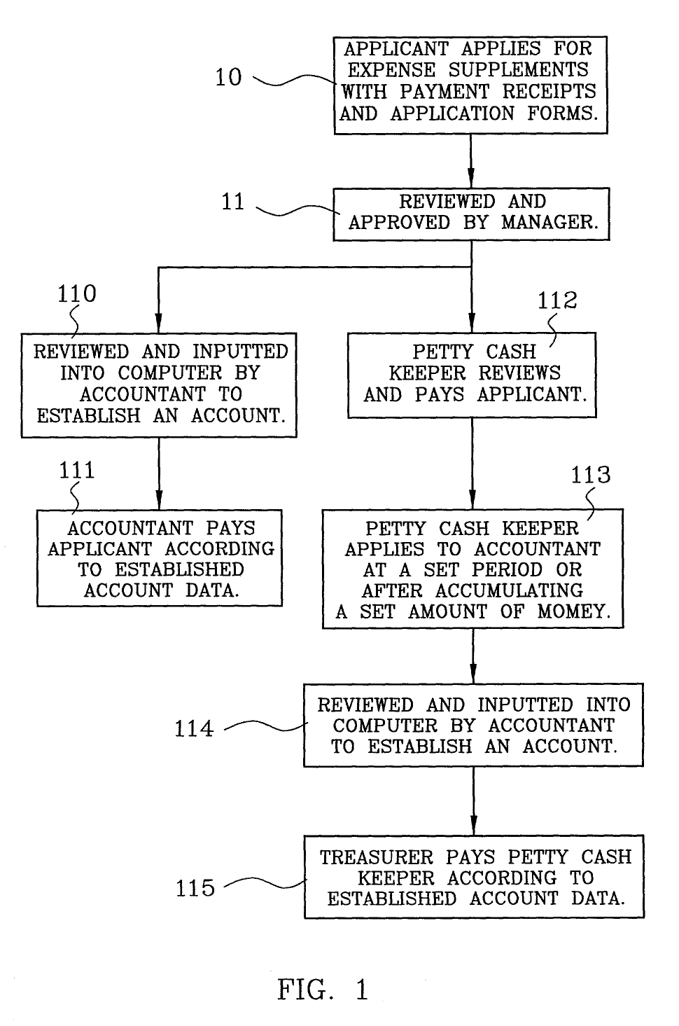

FIG. 2 is a flow chart of the expenses reimbursement application operations in accordance to the present invention;

FIG. 3 is a screen view of the petty cash upper limit function setup in accordance to the present invention;

FIG. 4 is a screen view of the application item setup in employee expense application function setup in accordance to the present invention;

FIG. 5 is a screen view of the pre-drawn amount setup in employee expense application function setup in accordance to the present invention;

FIG. 6 is a screen view of the application item setup in expense application and account establishment function setup in accordance to the present invention;

FIG. 7 is a screen view of the cancelled out temporary payment/employee pre-drawn setup in expense application and account establishment function setup in accordance to the present invention;

FIG. 8 is a screen view of the credit item setup in expense application and account establishment function setup in accordance to the present invention;

FIG. 9 is a screen view of the credit item setup in expense application and account establishment function setup in accordance to the present invention;

FIG. 10 is a screen view of the payment/reimbursement operation setup in the petty cash management function setup in accordance to the present invention;

FIG. 11 is a screen view of the important abstract setup in accordance to the present invention;

FIG. 12 is a screen view of the application items of petty cash management function setting in accordance to the present invention.

### DESCRIPTION OF THE PREFERRED EMBODIMENT

The invention disclosed herein is directed to an improve expense reimbursement application method of the accounting system in an ERP system. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

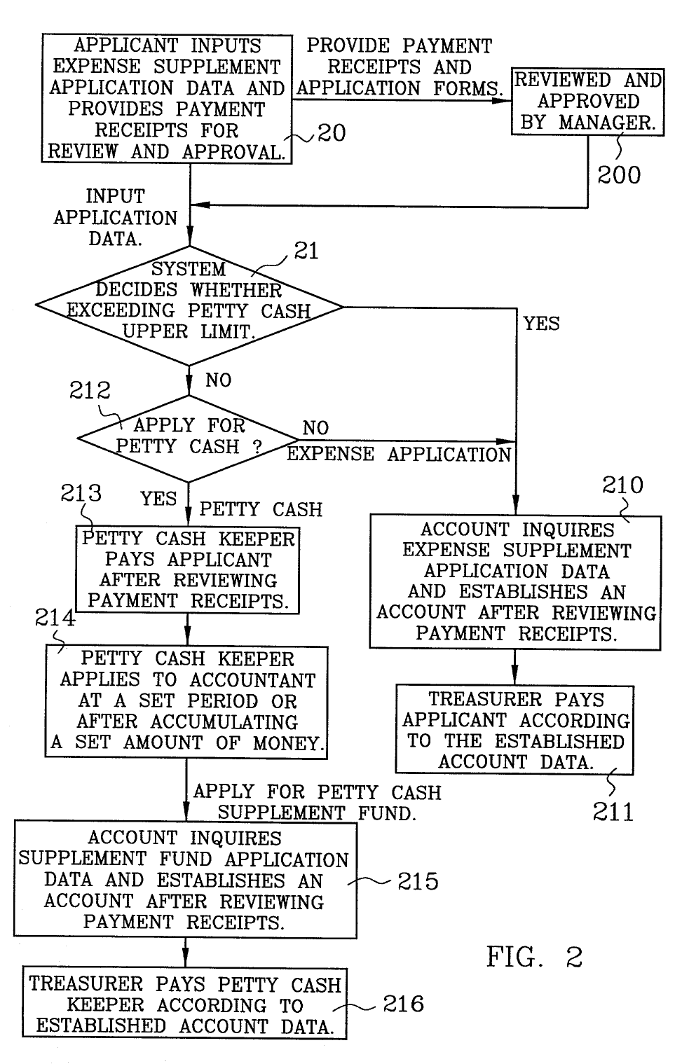

Please referring to FIG. 2, a flow chart of the expense reimbursement application operations in according to the present invention comprises. First, users set a petty cash upper limit in the accounting system. The expense reimbursement application operations start with applicants inputting expense reimbursement application data into the accounting system and providing payment receipts 20 for review and approval, then the payment receipts are reviewed and approved by managers 200. Then the accounting system decides whether the applied amount exceeding the petty cash upper limit according to the expense reimbursement application data 21. If exceeding the petty cash upper limit, the accounting system proceeds expense application procedures, which comprises: first, accountants inquire the expense reimbursement application data and establish an account after reviewing the payment receipts 210; then treasurers pay the applicants according to the established account data 211.

If not exceeding the petty cash upper limit, the accounting system decides whether to proceed with petty cash application procedures 212. If it decides not to apply for petty cash, then proceed the expense application procedures. If it decides to apply for petty cash, then proceed the petty cash application procedures, i.e., petty cash keepers inquire the expense reimbursement application data and pay the applicants after reviewing the payment receipts 213.

At a set period or after accumulating a set amount of money, the petty cash keepers apply to the accountants 214 to proceed petty cash reimbursement fund procedures, which comprises: apply for petty cash reimbursement fund, then the accountants inquire expense reimbursement application data and establish an account after reviewing the payment receipts 215; finally, the treasurers pay the petty cash keepers according to the established account data 216.

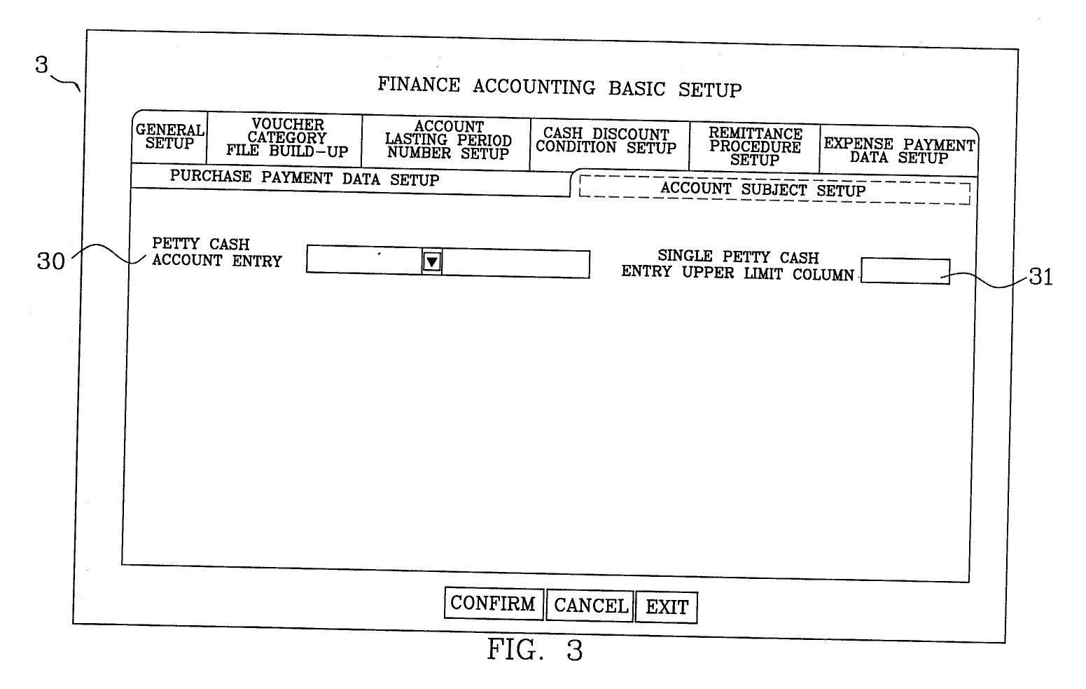

As stated above, the embodiment of the present invention, referring to FIG. 3, provides a petty cash upper limit function setup 3 to set the petty cash upper limit, wherein the petty cash upper limit function setup 3 further includes a petty cash establishment account entry column 30 and a single petty cash entry upper limit column 31 to allow companies input the petty cash upper limits and save it in the system of the present invention.

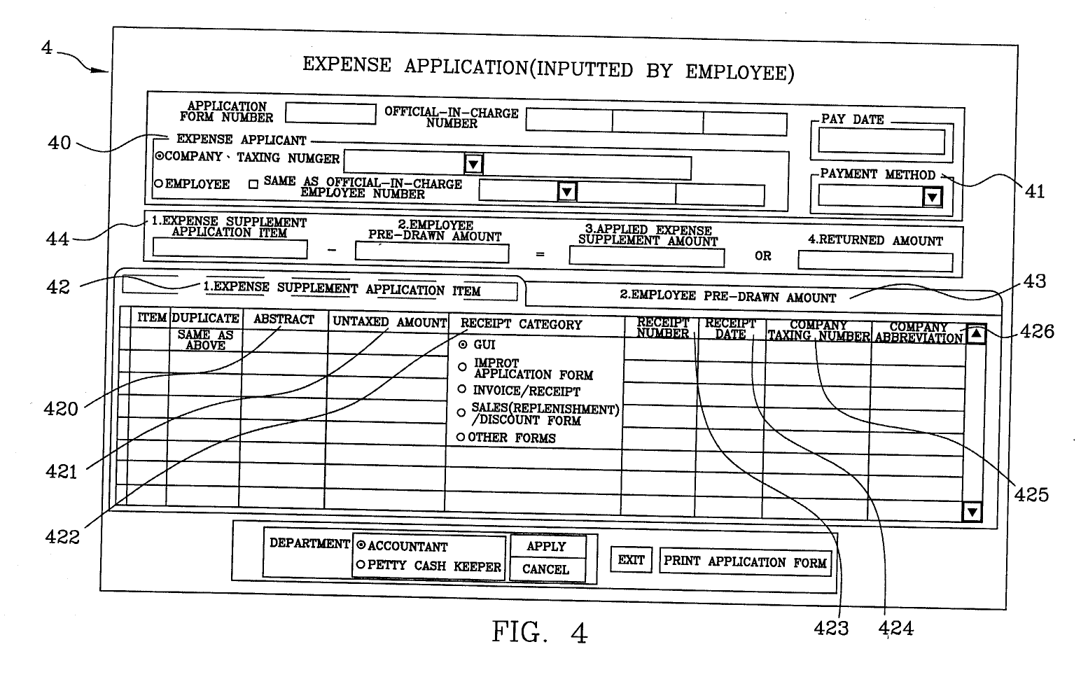

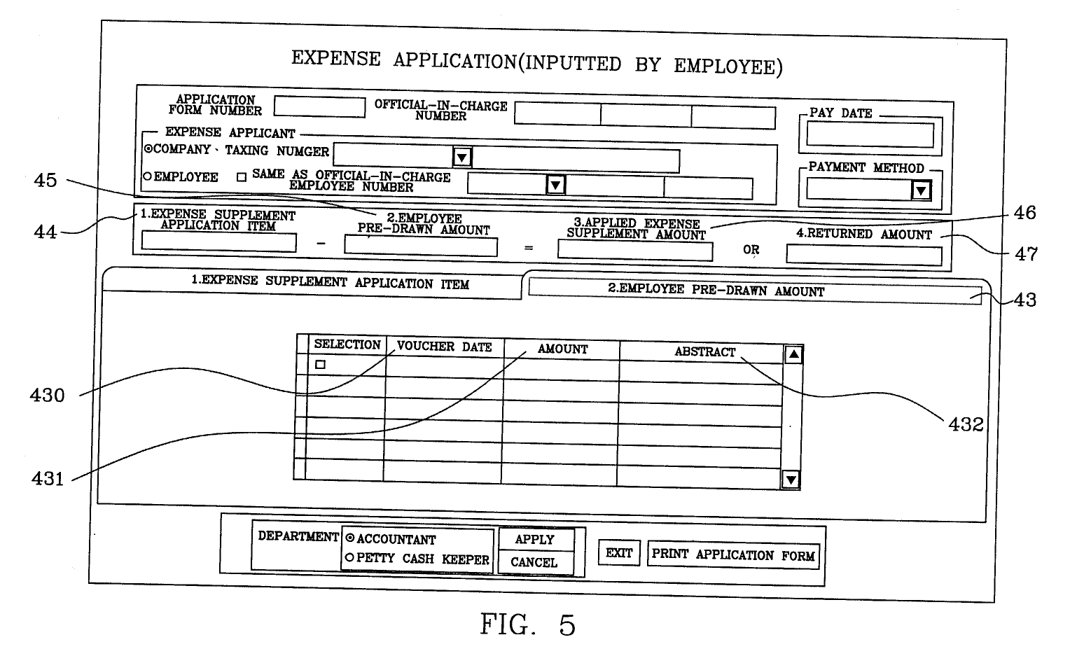

After the expenses occurred, the applicants input the expense reimbursement application data into the accounting system. Please refer to FIG. 4 and FIG. 5, an embodiment of the present invention, which provides an employee expense application function setup 4 for employees to input data, wherein the employee expense application function setup 4 includes an applicant column 40 a payment method column 41, and also includes an expense reimbursement application item setup 42 and an employee pre-drawn amount setup 43.

FIG. 4 is a screen view used to demonstrate the details of expense reimbursement application item setup 42, which further includes expense abstract 420, untaxed amount 421, receipt category 422, receipt number 423, receipt date 424, company taxing number 425, and company abbreviation 426 columns to be inputted by employees according to their needs. After the employees input data, item by item, into the expense reimbursement application item setup 42, the system automatically sums up the total applied expense reimbursements and show it in an “expense reimbursement application item” column 44.

FIG. 5 is a screen view used to demonstrate the details of employee pre-drawn amount setup 43, which further includes voucher date 430, amount 431, and abstract 432 columns to be inputted by employees according to their needs. If employees have pre-drawn in advance, then they are able to use the employee pre-drawn amount setup 43 to inquire their pre-drawn data and, at the same time, select some of the pre-drawn items to be cancelled out. After selection, the system automatically sums up the selected pre-drawn items and shows the total in an employee pre-drawn amount column 45, and it also deducts the number in the employee pre-drawn amount column 45 from the number in the expense reimbursement application item column 44 and shows the result in an applied expense reimbursement amount column 46 or a paid amount column 47 to notify the applicants the amount they should pay or be paid this time.

The system decides whether the applied amount exceeds the petty cash upper limit according to the petty cash upper limit function setup 3 in FIG. 3. If the applicants can only apply to the accountants for expense reimbursements, the system automatically shuts down the “petty cash keeper” function. If it is not the case, the system allows and suggests the applicants to apply for petty cashes. After the applicants input the application data and complete the application process, the system automatically transfers the expense reimbursement application data accordingly to the applied entities to the petty cash database or the expense application database for inquiry. For the applicants, they are required to print out the application forms and provide expense payment receipts, according to the company regulations, to be reviewed and approved by managers, and then sent to the petty cash keepers or the accountants.

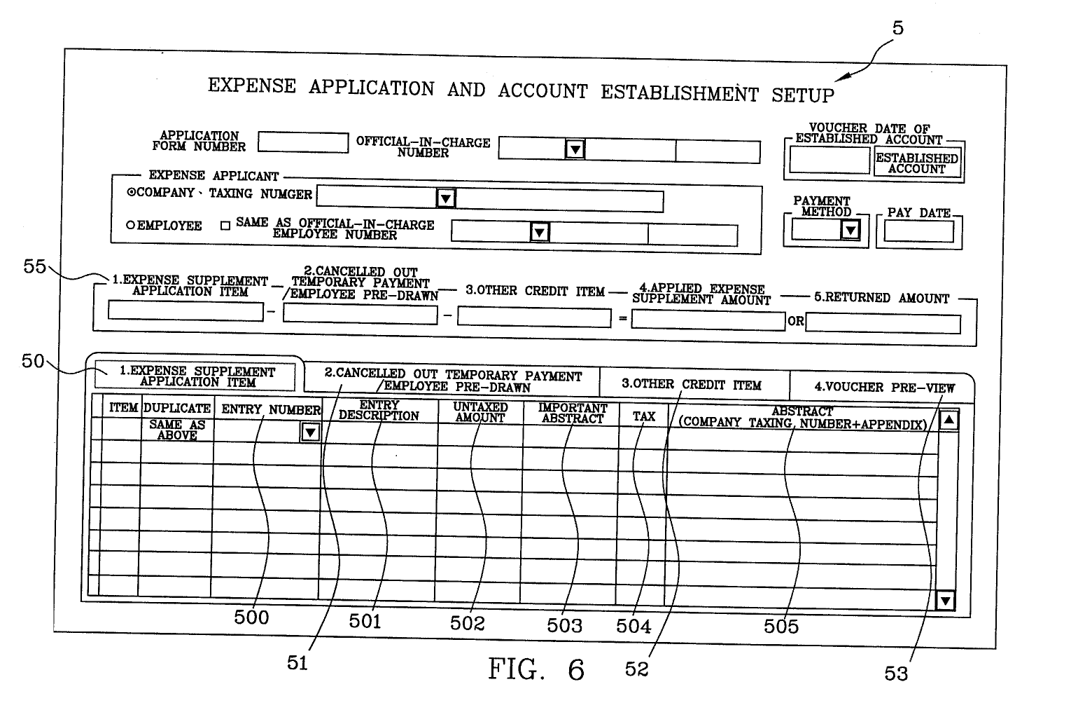

FIG. 6 to FIG. 9 are the screen views to demonstrate an expense application and account establishment function setup 5 provided by an embodiment of the present invention to allow the accountants inquiring the expense reimbursement application data inputted by the general employees and the petty cash keepers, wherein the expense application and account establishment function setup 5 further comprises expense reimbursement application item 50, cancelled out temporary payment/employee pre-drawn 51, other credit item 52, or voucher pre-view 53 setups.

In FIG. 6, when selecting the expense reimbursement application item setup 50, it further includes entry number 500, entry description 501, untaxed amount 502, important abstract 503, tax 504, and abstract 505 columns to be reviewed or revised by the accountants, and the system sums up the total amount and shows it in an expense reimbursement application item column 55.

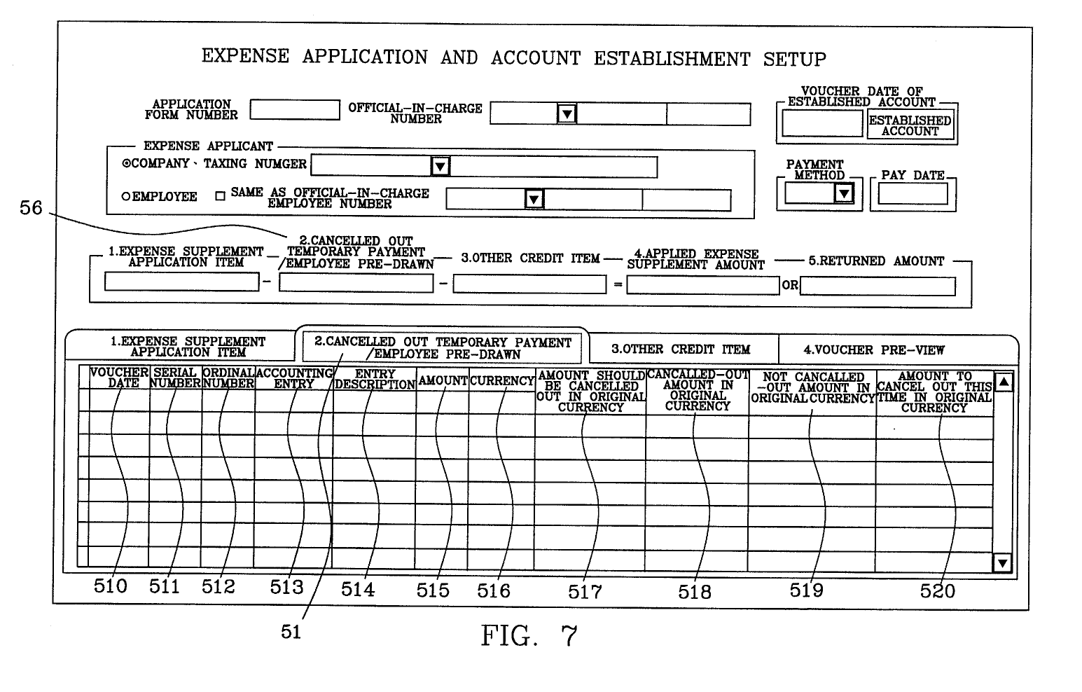

In FIG. 7, when selecting the cancelled out temporary payment/employee pre-drawn setup 51, it further includes voucher date 510, serial number 511, ordinal number 512, accounting entry 513, entry description 514, amount 515, currency 516, amount should be cancelled out in original currency 517, cancelled-out amount in original currency 518, not cancelled-out amount in original currency 519, and amount to cancel out this time in original currency 520 columns to be reviewed or revised, and the system sums up the total amount and shows it in an cancelled out temporary payment/employee pre-drawn column 56.

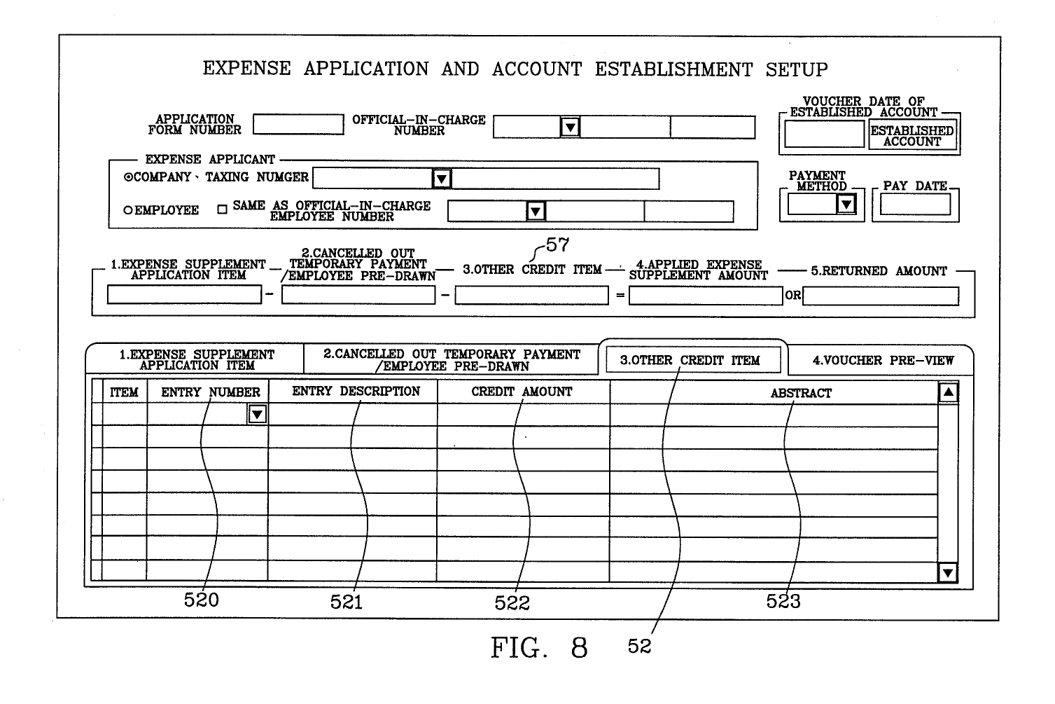

In FIG. 8, when selecting the other credit item setup 52, it further includes entry number 520, entry description 521, credit amount 522, and abstract 523 columns to be reviewed or revised, and the system sums up the total amount and shows it in an other credit item setup column 57.

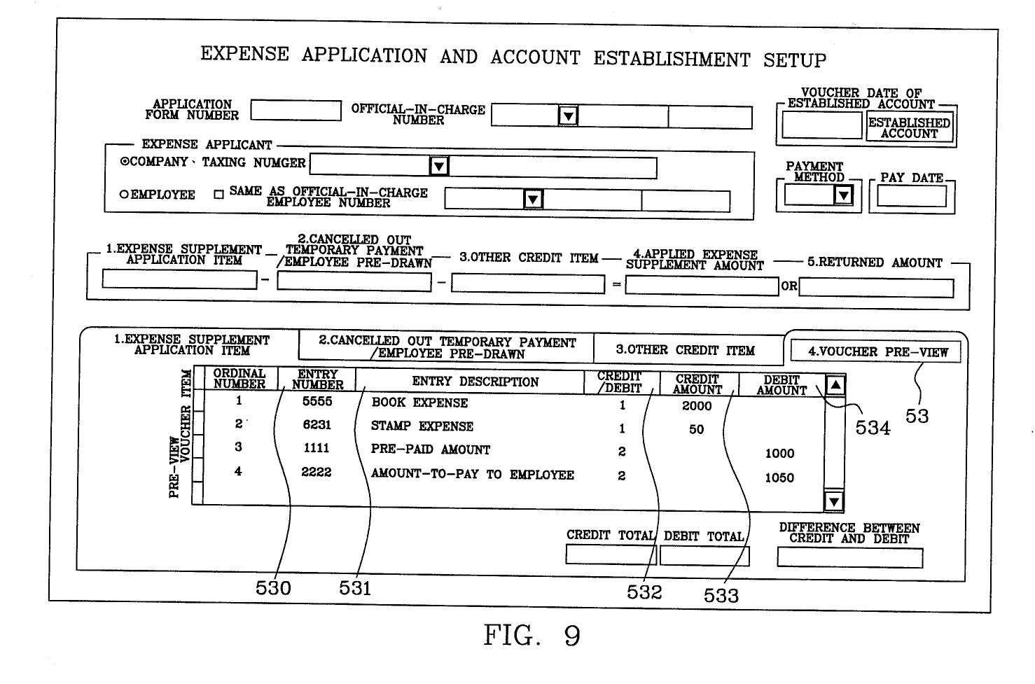

In FIG. 9, when selecting the voucher pre-view setup 53, it further includes entry number 530, entry description 531, debit/credit 532, debit amount 533, and credit amount 534 columns.

Therefore, when the accountants receive the payment receipts and expense reimbursement application forms from the applicants or the petty cash keepers, they perform the inquiring operations on the screen shown in FIG. 6 according to the numbers of the expense reimbursement application forms, and then the system automatically displays the related data inputted by the applicants or the petty cash keepers. The accountants can review and revised the data items of this application, and select or revise the accounting entries of the established account.

For the cancelled out temporary payment/employee pre-drawn amount, on the screen of the cancelled out temporary payment/employee pre-drawn setup, it is able to inquire the related data of temporary payment or pre-drawn amount of the applicants and select the entry items to be cancelled out during the employee expense reimbursement application procedures to be reviewed and revised by the accountants. On the other hand, in order to cancel out other credit accounts, the accountants can input the cancelled out accounts through the other credit item setup (FIG. 8).

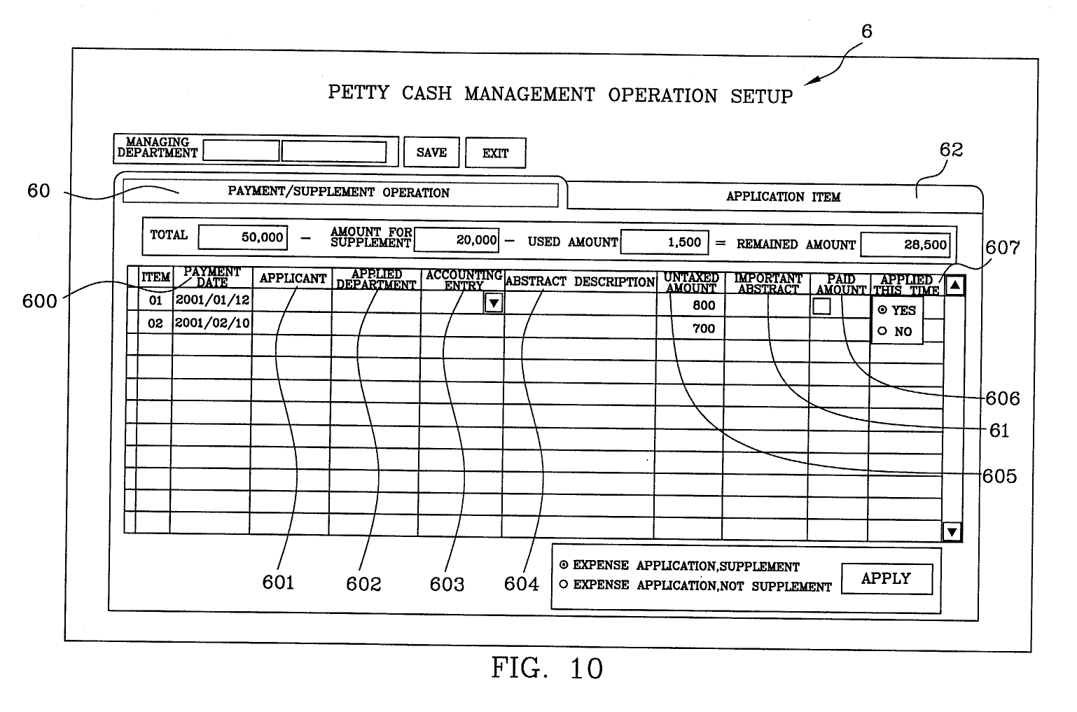

FIG. 10 to FIG. 12 are the screen views to demonstrate an petty cash management function setup 6 provided by an embodiment of the present invention, especially for the petty cash keepers, to allow the petty cash keepers manage the petty cashes, wherein the petty cash management function setup 6 includes a payment/reimbursement operation setup 60 and an application item setup 62.

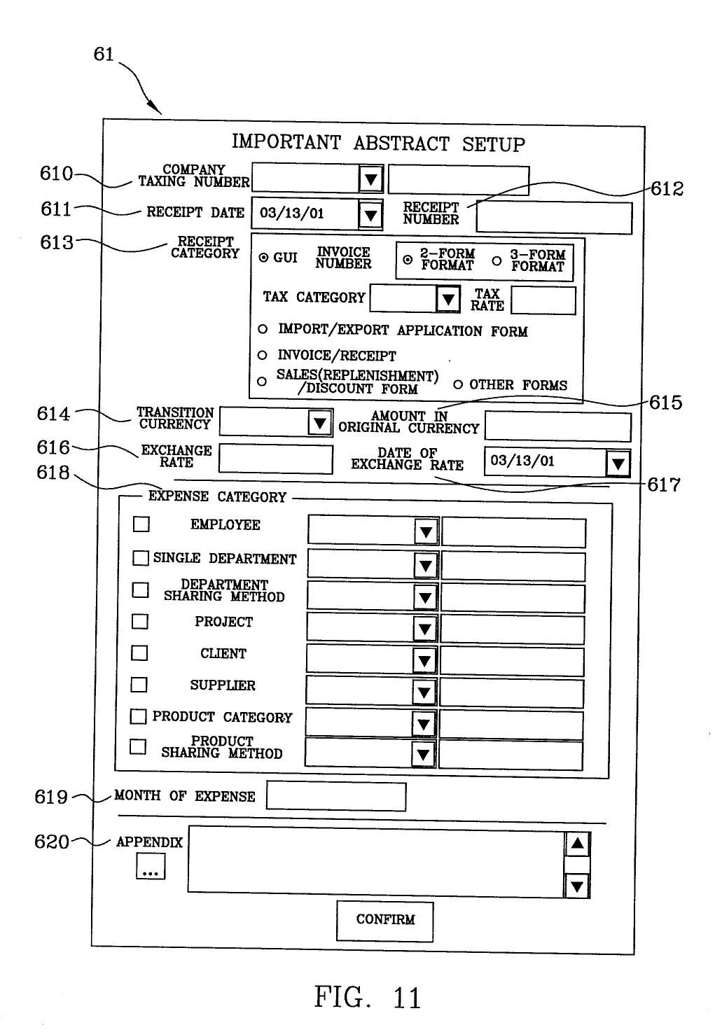

In FIG. 10, when selecting the payment/reimbursement operation setup 60, it includes payment date 600, applicant 601, applied department 602, accounting entry 603, abstract description 604, untaxed amount 605, pay this time 606, and applied this time 607 columns to be reviewed or revised by the petty cash keepers, and, in addition, the setup further includes an important abstract function 61 to be selected, referring to FIG. 11 for details.

In FIG. 11, the important abstract setup 61 includes company taxing number 610, receipt date 611, receipt number 612, receipt category 613, transition currency 614, amount in original currency 615, exchange rate 616, date of exchange rate 617, expense category 618, month of expense 619, and appendix 620 columns to be inquired by the petty cash keepers, wherein the receipt category 613 further includes invoice number, import and export application form, invoice/receipt, sales (replenishment)/discount form, or other form columns.

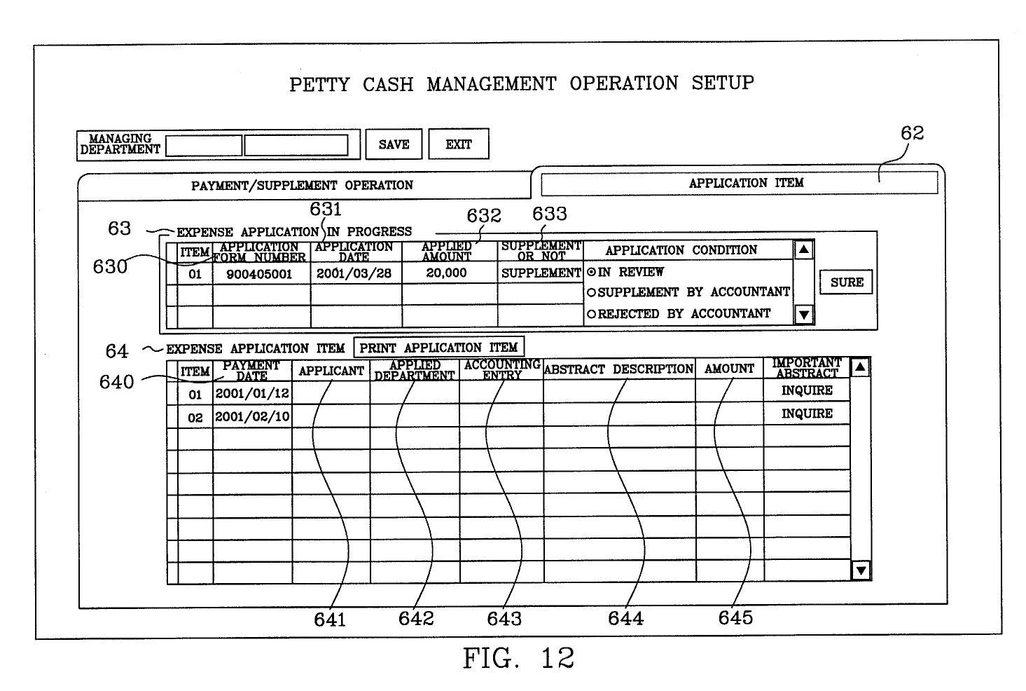

In FIG. 12, when selecting the application item setup 62, it includes an expense application setup 63 and an expense application item setup 64 functions, wherein the expense application setup 63 further includes application form number 630, application date 631, applied amount 632, or reimbursement or not 633 columns; and the expense application item setup 64 further includes reimbursement paid date 640, applicant 641, applied department 642, accounting entry 643, abstract description 644, or amount 645 columns.

Therefore, the petty cash keepers, when they receive the approved payment receipts from the applicants, inquire the applied petty cash data on the screen of the petty cash management function setup (FIG. 10). The petty cash keepers click on the important abstract column 61 based on the application data provided by the applicants of this application, then the system displays the screen of the important abstract function (FIG. 11). After reviewing the data of receipt number 612, receipt category 613, and amount in original currency 615, the petty cash keepers click on the certain button to return to the petty cash management function setup (FIG. 10) and then input the petty cash entry of its established account, but if they are not sure of the accounting entry of the established account, then the inputting procedure can be omitted. After clicking on the “paid” column 61 to save the inputted data, the petty cash keepers pay the expense reimbursements to the applicants. At the same time, the system automatically sums up the expense reimbursements paid to the applicants and shows it in the “used-up amount” column, and provides the data of sum, amount for reimbursement, remaining sum, etc. to keep the petty cash keepers informed of the up-to-date conditions of the petty cash usage.

When encountering special conditions, for example, the applicants don't have time to input data but in urgent need for petty cashes, the system also allows the petty cash keepers to input data into the related columns on the operation screen shown in FIG. 10 and then pay the applicants. The system also automatically records data to be used for establishing expense application accounts.

At a set period or after accumulating a set amount of money, in order to proceed the petty cash reimbursement operations, the system allows the petty cash keepers to enter the screen of FIG. 10, and click on “yes” in the “whether applied this time” column 607 for each data item of this petty cash reimbursement application, then select the applied items of this application and whether to reimbursement petty cash reimbursement fund, and, finally, click on the “apply” button to complete the application and reimbursement operations. The system not only automatically increases the amount used for reimbursement funds and calculates the remaining amount, but also automatically transfers data to the expense application account establishment operations for reviewing and establishing accounts.

The Advantages of the Present Invention:

The stated improved expenses reimbursement application method effectively provides the complete procedures of the expense application in an enterprise resource planning (ERP) system. The major advantages are stated as follows:

(1) In the improved expense application procedures in accordance to the present invention, the system controls more operations. In the prior art, the data input operations are performed by the accountants, while the present invention allows the expense reimbursement applicants to do the inputting, which reduces the input workload of the accountants. The system also controls the expense application in financial management. In addition, the system controls the petty cash management of the petty cash keepers, which improves the accuracy of account data.

(2) The present invention provides setup and control mechanisms for the application procedures, which often cause confusions among the applicants, to avoid the errors of exceeding the petty cash upper limit and reduce time for human decision-making.

(3) Since the expense application data are automatically transferred to the petty cash management after inputted by the applicants, and then summed up and transferred to the expense application of accounting system to simplify the work of account summarization and reimbursement application of the petty cash keepers and, at the same time, reduce the workload of verifying accounts of the accountants.

(4) All inputting procedures and data transferences of the present invention are handled by the same ERP system and in no need of transferring data among different systems, so it not only maintains data consistency and avoid errors, but also needs no extra information personnel to maintain different systems.

In summation, the improved expense reimbursement application method, in both objective and effectiveness, achieves great improvements and has great usage values for the industry. The present invention is a new invention not yet seen on the market and satisfies the requirements of utility patent application.

I claim:

1. An expenses reimbursement application method of an accounting system used in computerized financial management, comprises the following steps:
beginning said expense reimbursement application method operations, then setting a petty cash upper limit in said accounting system;
inputting expense reimbursement application data into said accounting system, and providing payment receipts for review and approval;
deciding said accounting system whether the applied amount exceeds said petty cash upper limit;
proceeding an expense application procedure by said accounting system when said applied amount exceeding said petty cash upper limit;
proceeding a petty cash application procedure by said accounting system when said applied amount not exceeding said petty cash upper limit;
proceeding a petty cash reimbursement fund procedure at a set period or after accumulating a set amount of money so as to establish a petty cash account, further giving out petty cash reimbursement fund according to the data of said established accounting system.

2. The expenses reimbursement application method as recited in claim 1, wherein setting said petty cash upper limit is used to provide a petty cash upper limit function setup, and said petty cash upper limit function setup includes a petty cash establishment account entry column and a single petty cash entry upper limit column.

3. The expenses reimbursement application method as recited in claim 1, wherein said expense application procedures comprises the steps of inquiring said expense reimbursement application data after said payment receipts are reviewed and approved; establishing an account, and paying applicants according to said established account data; furthermore, said petty cash application procedures comprises the steps of inquiring said expense reimbursement application data and paying applicants after said payment receipts are reviewed and approved; wherein, said petty cash reimbursement fund procedures comprises the following steps:
applying for petty cash reimbursement fund;
inquiring said reimbursement fund application data,
establishing an account after said payment receipts are reviewed and approved; and
paying petty cash keepers according to said established account data.

4. The expenses reimbursement application method as recited in claim 1, wherein said expense reimbursement application data comprises an employee expense application function setup which further includes an applicant, a payment method, an application item, and an employee pre-drawn amount setups.

5. The expenses reimbursement application method as recited in claim 3, wherein said expense reimbursement application data can be inquired by an expense application and accounted establishment function setup, said expense application and accounted establishment function setup further comprises an expense reimbursement application item, a cancelled out temporary payment/employee pre-drawn, a lot of credit items, or a voucher pre-view setup.

6. The expenses reimbursement application method as recited in claim 3, wherein while said expense reimbursement application data can be inquired by a petty cash management function setup.

7. The expenses reimbursement application method as recited in claim 4, wherein said expense reimbursement application item setup further includes selecting at least one of an expense abstract, an untaxed amount, a receipt number, a receipt date, and a company taxing number columns.

8. The expenses reimbursement application method as recited in claim 4, wherein said employee pre-drawn amount setup further includes selecting at least one of a voucher data, an amount, or an abstract column.

9. The expenses reimbursement application method as recited in claim 4, said expense reimbursement application data include an expense reimbursement application item, an employee pre-drawn amount, an applied expense reimbursement amount, or a paid amount columns for inquiring, furthermore, if pre-drawn a certain amount in advance, also include deducting said “employee pre-drawn amount” from the total amount in said “application item” column by the system further showing the result in said “applied expense reimbursement amount” column or “paid amount” column.

10. The expenses reimbursement application method as recited in claim 5, wherein said expense reimbursement application item setup further comprises an item description column and a tax amount column; and said expense reimbursement application item setup further includes selecting at least one of the following columns: a voucher date, a serial number, an ordinal number, an accounting entry, an entry description, an amount, a currency, a cancelled-out amount in original currency, a not cancelled-out amount in original currency, and amount to cancel out this time in original currency.

11. The expenses reimbursement application method as recited in claim 5, wherein said other credit item setup further includes selecting at lest one of an entry number, an entry description, a debit amount, a credit amount, or an abstract column.

12. The expenses reimbursement application method as recited in claim 5, wherein said voucher pre-view setup further includes selecting from an entry number, an entry description, a debit amount, or a credit amount column.

13. The expenses reimbursement application method as recited in claim 6, wherein said petty cash management function setup includes a payment/reimbursement operation setup or an application item setup.

14. The expenses reimbursement application method as recited in claim 7, wherein said receipt category setup includes an invoice number, an import and export application form, an invoice/receipt, sales (replenishment)/discount form, or other form column setups.

15. The expenses reimbursement application method as recited in claim 13, wherein said payment/reimbursement operation setup further includes selecting at least one of the following columns: a payment date, an applicant, an applied department, an accounting entry, an abstract description, an untaxed amount, an whether pay or applied this time item.

16. The expenses reimbursement application method as recited in claim 13, wherein said payment/reimbursement operation setup further includes an important abstract setup; and said important abstract setup further includes selecting at least one of the following column setups: a company taxing number, a receipt date, a receipt number, a receipt category, an amount in original currency, a transition currency, an exchange rate, a date of exchange rate, am expense category, a month of expense, and an appendix item.

17. The expenses reimbursement application method as recited in claim 13, wherein said application item setup includes an expense application setup and/or an expense application item setup.

18. The expenses reimbursement application method as recited in claim 16, wherein said expense category setup includes an employee, a single department, a department sharing policy, a project, a client, a supplier, a product category, and a product sharing policy column setup.

19. The expenses reimbursement application method as recited in claim 16, wherein said expense application setup includes selecting from an application form number, an application date, an applied amount, or a reimbursement or a not column setup.

20. The expenses reimbursement application method as recited in claim 16, wherein said expense application item setup includes selecting from at least one of a reimbursement paid date, an applicant, an applied department, an accounting entry, an abstract description, or an amount column setup.
